(19) United States
(12) Patent Application Publication
(10) Pub. No.: US 2025/0170552 A1
(43) Pub. Date: May 29, 2025

(54) COMPOSITE BODY

(71) Applicant: SAINT-GOBAIN CERAMICS & PLASTICS, INC., Worcester, MA (US)

(72) Inventors: Ian Victor KIDD, Oxford, MA (US); Wesley S. TOWLE, North Grosvenordale, CT (US); Choung-Houng LAI, Acton, MA (US); Zachary COSTANTINO, Waltham, MA (US); Joseph William EUN, Marlborough, MA (US); Carl Russell KALLGREN, Dayville, CT (US); Janos E. KANYO, Worcester, MA (US); Lynne Kathleen LAROCHELLE-RICHARD, Littleton, MA (US)

(21) Appl. No.: 18/960,278

(22) Filed: Nov. 26, 2024

Related U.S. Application Data
(60) Provisional application No. 63/603,205, filed on Nov. 28, 2023.

(51) Int. Cl. B01J 20/04; B01J 20/28; B01J 20/282; B01J 20/30

(52) U.S. Cl. CPC B01J 20/04; B01J 20/28004; B01J 20/28011; B01J 20/28016; B01J 20/28026; B01J 20/282; B01J 20/3042; B01J 20/3085; B01J 2220/52

(57) ABSTRACT

An article comprising a composite body, wherein the composite body can comprise ceramic particles distributed within a binder. The binder can include a cross-linked polymer of a first polymer and a second polymer wherein the first polymer is a water-soluble polymer, and the second polymer is a water-insoluble polymer. The composite body can have a water stability factor (WS) of at least 70%, and may be adapted for adsorbing and desorbing lithium ions. The composite body can further have a high bulk compression strength of at least 70 N.

### CROSS-REFERENCE TO RELATED APPLICATION(S)

This application claims priority under 35 U.S.C. § 119(e) to U.S. Provisional Patent Application No. 63/603,205, filed Nov. 28, 2023, by Ian Victor KIDD et al., entitled “COMPOSITE BODY,” which is assigned to the current assignee hereof and incorporated herein by reference in its entirety for all purposes.

### FIELD OF THE DISCLOSURE

The present disclosure relates to an article comprising a composite body adapted for adsorbing and desorbing lithium ions, wherein the composite body comprises ceramic particles and a binder, the binder including a cross-linked polymer of a water-insoluble polymer and a water-soluble polymer.

### BACKGROUND

The current trend and future need for electrification requires very large quantities of batteries, specifically lithium-based batteries. Currently, lithium is mined from ore. However, to meet the increasing demand of lithium, direct lithium extraction (DLE) from brine is a method which is becoming more and more of importance in order to make use of lithium-ion containing brine. There exists a need to develop materials suitable for DLE which combine a specific adsorption/desorption capacity for lithium ions from brine, combined with a high water stability and strength.

### BRIEF DESCRIPTION OF THE DRAWINGS

The present disclosure may be better understood, and its numerous features and advantages made apparent to those skilled in the art by referencing the accompanying drawings.

FIG. 1 includes a graph illustrating the lithium-ion (Li+) adsorption rate of a column filled with composite bodies by passing a Li+-containing brine through the column according to one embodiment.

### DETAILED DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The present disclosure is directed to an article comprising a composite body. The composite body can comprise ceramic particles distributed within a binder, wherein the binder includes a cross-linked polymer of a first polymer and a second polymer. The first polymer of the cross-linked polymer can include at least one water-insoluble polymer and the second polymer may include at least one water-soluble polymer. The composited body is adapted for adsorbing and desorbing lithium ions; has a water stability factor (WS) of at least 70%; and a bulk compression strength of at least 70 N.

As used herein, the term polymer can mean homopolymer or copolymer.

As used herein, the term “first polymer” is used interchangeable with the term “water-insoluble polymer,” and means that it has a water-solubility at 20° C. of not greater than 0.1 g/l.

As used herein, the term “second polymer” is used interchangeable with the term “water-soluble polymer,” and means that the water solubility at 20° C. is at least 1 g/l, or at least 5 g/l, or at least 10 g/l.

It has been surprisingly found that Li⁺ adsorbing composite bodies can be prepared with a desired capacity of Li⁺ adsorption/desorption from brine, wherein the composite bodies can be prepared in an efficient process, are water-stable, have a high strength, and can be reused multiple times.

In one embodiment, the method of forming the composite body can comprise: (i) preparing a green body mixture by combining ceramic particles capable of adsorbing/desorbing lithium ions, a water-insoluble polymer (first polymer), a water-soluble polymer (second polymer), and water. In a second step (ii), the green body mixture can be subjected to curing at elevated temperatures, wherein the first polymer and the second polymer can undergo cross-linking reactions and form together a cross-linked polymer within the cured body. The cross-linked polymer can function as a matrix wherein the ceramic particles may be evenly distributed and held together. In a third step (iii), the cured composite body can be mechanically processed to obtain the composite body. For example, in one aspect, the cured composite body may be a sheet, which can be divided and crushed into a plurality of composite bodies having a certain size range.

In one aspect, the water-insoluble polymer (first polymer) can comprise functional groups selected from hydroxyl groups, amine groups, acrylate groups, vinyl groups, carboxyl groups, aldehyde groups, hydroxyl groups, or carbodiimide groups. In non-limiting examples, the first polymer can be an acrylate polymer, a styrene polymer, a styrene-acrylate copolymer, a vinyl acetate copolymer, a styrene-butadiene copolymer, or any combinations thereof. In a certain aspect, the first polymer can be self-crosslinking.

In a particular aspect, the first polymer can be an acrylate polymer. As used herein, the term “acrylate polymer” can be a substituted or an unsubstituted acrylate polymer, for example, it can be an alkylacrylate polymer, such as a methacrylate polymer. The acrylate polymer can contain functional groups which provide the capability of being self-crosslinking.

In another aspect, the water-soluble polymer (second polymer) can comprise carboxyl groups, hydroxyl groups, amine groups or a combination thereof. Non-limiting examples of the water-soluble polymer can be: a polysaccharide, or a polyvinyl alcohol (PVA), or a polyethylene glycol (PEG), or a polypropylene glycol (PPG).

In one embodiment, the water-soluble polymer can be a polysaccharide. The polysaccharide can be a cellulose derivative, or a modified starch, or an alginate, or a combination thereof.

In a particular aspect, the polysaccharide may be a cellulose derivative selected from carboxymethyl cellulose (CMC), or hydroxyethyl cellulose (HEC), or hydroxypropyl cellulose (HPC). If the cellulose derivative comprises carboxyl groups, like in CMC, it can be used in the sodium salt form.

In a certain aspect, the water-soluble polysaccharide can be a combination of a cellulose derivative and an alginate. In a particular aspect, the water-soluble polymer (second polymer) may consist essentially of the combination of carboxymethyl cellulose and alginate. As used herein, consisting essentially of carboxymethyl cellulose and alginate means that an amount of other water-soluble polymers is not greater than 0.5 wt % based on the total weight of the water-soluble polymer of the binder.

In a further particular aspect, the weight percent ratio of CMC to the alginate may range from 2:1 to 1:2, or from 1.5:1 to 1:1.5.

In another embodiment, the weight percent ratio of the water-insoluble polymer (first polymer) to the water-soluble polymer (second polymer) of the binder can be at least 1:1, or at least 2:1, or at least 4:1, or at least 5:1. In another aspect, the ratio of first polymer to the second polymer may be not greater than 50:1, or not greater than 40:1, or not greater than 30:1, or not greater than 20:1 or not greater than 15:1, or not greater than 10:1, or not greater than 5:1.

The ceramic particles can comprise a material capable of adsorbing lithium ions. In non-limiting examples, the ceramic particles can include lithium titanate, or lithium bayerite, or layered double hydroxide aluminate, or manganese oxide, or any combination thereof.

In a particular aspect, the ceramic particles can consist essentially of lithium bayerite. In another particular aspect, the ceramic particles may consist essentially of lithium titanate. As used herein, consisting essentially of lithium bayerite or lithium titanate, means that the amount of lithium bayerite or lithium titanate is at least 99 wt % based on the total weight of the ceramic particles.

In one aspect, the curing of the green body mixture (ii) can be conducted at a temperature of at least 80° C., or at least 100° C., or at least 140° C., or at least 170° C., or at least 200° C. In another aspect, curing may be conducted at a temperature not greater than 450° C., or not greater than 400° C., or not greater than 350° C., or not greater than 300° C., or not greater than 250° C. During the curing, the first polymer and the second polymer can cross-link with each other to form a cross-linked polymer.

The amount of binder in the formed composite body can correspond to the combined amount of first polymer and second polymer used for making the green body mixture, based on the dry weight of the composite body.

In another aspect, the binder can comprise in addition to the first polymer and the second polymer a cross-linking agent which may further assist in the cross-linking of the first and second polymer.

In a further aspect, at least 90 wt % of the binder or the composite body can be organic polymeric binder of the first polymer and second polymer, or at least 95 wt % of the binder, or at least 98 wt %, or at least 99 wt %, or at least 99.5 wt %, or 100 wt %.

In one aspect, the amount of the binder of the composite body can be at least at least 13 wt % based on the total weight of the composite body, or at least 15 wt %, or at least 18 wt %, or at least 20 wt %, or at least 22 wt %, or at least 25 wt %, or at least 28 wt %, or at least 30 wt %. In another aspect, the amount of binder may be not greater than 60 wt % based on the total weight of the composite body, or at least 55 wt %, or at least 50 wt %, or not greater than 45 wt %, or not greater than 43 wt %, or not greater than 40 wt %, or not greater than 35 wt %, or not greater than 30 wt %, or not greater than 25 wt %, or not greater than 23 wt %. The amount of binder can be a number between any of the minimum and maximum numbers listed above. As used herein, the total weight of the composite body refers to the dry weight of the composite body, excluding the presence of water although water may be to a certain amount being present in the composite body.

After the curing, the cured composite body can be mechanically processed to obtain a desired shape and size. For example, the cured composite can be subjected to a crushing and sieving to obtain a plurality of composite bodies having a desired particle size range, herein also called granules or pellets.

In one aspect, the average size (D50) of the plurality of composite bodies can be at least 1 micron, or at least 5 microns, or at least 7 microns, or at least 10 microns, or at least 50 microns, or at least 100 microns, or at least 200 microns, or at least 300 microns, or at least 400 microns, or at least 500 microns, or at least 1000 microns, or at least 2000 microns. In another aspect, average size of the plurality of composite bodies may be not greater than 5000 microns, or not greater than 3000 microns, of not greater than 2000 microns, or not greater than 1000 microns, or not greater than 700 microns. The average size (D50) of the plurality of composite bodies can be a number between any of the minimum and maximum numbers listed above, such as from 50 microns to 800 microns, or from 200 microns to 600 microns.

The composite body of the present disclosure can have a high water-stability and being suitable for adsorbing lithium ions from highly concentrated inorganic salt solutions, also called brine.

In one embodiment, the water stability, which is herein expressed as water stability factor (WS), can be at least 75%, or at least 80%, or at least 82%, or at least 84%, or at least 86%, or at least 88%, or at least 90%, or at least 92%, or at least 94%, or at least 95%, or at least 96%. In another embodiment, the water stability factor may be not greater than 99.9%, or not greater than 99.5 wt %, or not greater than 99 wt %. As used herein, the water stability factor expresses the ratio of dry weight of water-treated pellets/dry weight of original pellets multiplied with 100% after a defined water treatment.

The composite body can have breakthrough capacity for adsorbing lithium ions of at least 3.5 mg/g, or at least 4.0 mg/g, or at least 4.5 mg/g, or at least 5 mg/g, or at least 8 mg/g, or at least 10 mg/g, or at least 12 mg/g, or at least 14 mg/g, or at least 16 mg/g, or at least 18 mg/g, or at least 20 mg/g, or at least 22 mg/g, or at least 24 mg/g, or at least 26 mg/g. In another aspect, the breakthrough capacity for adsorbing lithium ions of the composite body may be 50 mg/g, or not greater than 40 mg/g, or not greater than 30 mg/g, or not greater than 20 mg/g, or not greater than 10 mg/g. The breakthrough capacity may be a value withing any of the above-cited numbers, such as from 3.5 mg/g to 35 mg/g, or from 4 mg/g to 15 mg/g. As used herein, and also defined in the experimental section, the breakthrough capacity refers to the point that the ratio of lithium ion adsorption reaches only 90% of efficiency, expressed as [Li]/[Li]0 of 0.1.

In one aspect a capacity difference between a total adsorption capacity for lithium ions and a corresponding break-through capacity for lithium ions may be not greater than 10 mg/g, or not greater than 5 mg/g, or not greater than 4 mg/g, or not greater than 3 mg/g, or not greater than 2.5 mg/g, or not greater than 2.0 mg/g, or not greater than 1.5 mg/g. In another aspect, the difference between total capacity and break-through capacity can be at least 0.5 mg/g, or at least 1.0 mg/g, or at least 1.5 mg/g.

In a further aspect the total capacity for adsorbing lithium ions of the composite body can be at least 4.0 mg/g, or at least 5 mg/g, or at least 6 mg/g, or at least 8 mg/g, or at least 10 mg/g, or at least 15 mg/g, or at least 20 mg/g, or at least 35 mg/g, or at least 40 mg/g, or at least 45 mg/g. In another aspect, the total capacity for adsorbing lithium ions may be not greater than 60 mg/g, or not greater than 55 mg/g, or not greater than 45 mg/g, or not greater than 35 mg/g, or not greater than 25 mg/g.

The composite body of the present disclosure can further have a high strength. In one aspect, the bulk compression strength of the composite body can be at least 75 N, or at least 80 N, or at least 90 N, or at least 100 N, or at least 120 N, or at least 140 N, or at least 160 N, or at least 180 N, or at least 200 N, or at least 250 N, or at least 300 N, or at least 330 N, or at least 360 N, or at least 390 N. In another aspect, the bulk compression strength of the composite body may be not greater than 600 N, or not greater than 550 N, or not greater than 400 N, or not greater than 350 N, or not greater than 300 N, or not greater than 250 N, or not greater than 200 N. The bulk compression strength can be a value between any of the minimum and maximum numbers listed above. As used herein, the bulk compression strength relates to the force needed to reduce a defined bulk volume of a plurality of composite bodies by 10 percent.

In another aspect, the composite body of the present disclosure can have a tap density of at least 0.4 g/cm3, or at least 0.45 g/cm3, or at least 0.5 g/cm3, or at least 0.55 g/cm3, or at least 0.6 g/cm3. In another aspect, the tap density may be not greater than 1 g/cm3, or not greater than 0.9 g/cm3, or not greater than 0.8 g/cm3, or not greater than 0.7 g/cm3. The tap density can be a value between any of the minimum and maximum values noted above.

As further demonstrated in the examples, the composite body of the present disclosure can be characterized of being adapted of adsorbing/desorbing lithium ions with high capacity from brine, and further combining the properties of high strength and water stability.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiments

Embodiment 1. An article comprising a composite body, the composite body comprising ceramic particles distributed within a binder, the binder including a cross-linked polymer of a first polymer and a second polymer, wherein the first polymer includes at least one water-insoluble polymer and the second polymer includes at least one water-soluble polymer; the composite body has a water stability factor (WS) of at least 70%; the composited body is adapted for adsorbing and desorbing lithium ions; and the composite body has a bulk compression strength of at least 70 N.

Embodiment 2. The article of Embodiment 1, wherein the amount of the binder is at least 13 wt % based on the total weight of the composite body, or at least 15 wt %, or at least 18 wt %, or at least 20 wt %, or at least 22 wt %, or at least 25 wt %, or at least 28 wt %, or at least 30 wt %.

Embodiment 3. The article of Embodiments 1 or 2, wherein an amount of the binder is not greater than 60 wt % based on the total weight of the composite body, or at least 55 wt %, or at least 50 wt %, or not greater than 45 wt %, or not greater than 43 wt %, or not greater than 40 wt %, or not greater than 35 wt %, or not greater than 30 wt %, or not greater than 25 wt %, or not greater than 23 wt %.

Embodiment 4. The article of any one of the preceding Embodiments, wherein a breakthrough capacity for adsorbing lithium ions of the composite body is at least 3.5 mg/g, or at least 4.0 mg/g, or at least 4.5 mg/g, or at least 5 mg/g, or at least 8 mg/g, or at least 10 mg/g, or at least 12 mg/g, or at least 14 mg/g, or at least 16 mg/g, or at least 18 mg/g, or at least 20 mg/g, or at least 22 mg/g, or at least 24 mg/g, or at least 26 mg/g.

Embodiment 5. The article of any one of the preceding Embodiments, wherein a breakthrough capacity for adsorbing lithium ions of the composite body is not greater than 50 mg/g, or not greater than 40 mg/g, or not greater than 30 mg/g, or not greater than 20 mg/g, or not greater than 10 mg/g.

Embodiment 6. The article of Embodiments 4 or 5, wherein a capacity difference between a total adsorption capacity for lithium ions and a corresponding break-through capacity for lithium ions is not greater than 5 mg/g, or not greater than 4 mg/g, or not greater than 3 mg/g, or not greater than 2.5 mg/g, or not greater than 2.0 mg/g or not greater than 1.5 mg/g.

Embodiment 7. The article of any one of the preceding Embodiments, wherein the bulk compression strength of the composite body is at least 75 N, or at least 80 N, or at least 90 N, or at least 100 N, or at least 120 N, or at least 140 N, or at least 160 N, or at least 180 N, or at least 200 N, or at least 250 N, or at least 300 N, or at least 330 N, or at least 360 N, or at least 390 N.

Embodiment 8. The article of any one of the preceding Embodiments, wherein the bulk compression strength of the composite body is not greater than 600 N, or not greater than 550 N, or not greater than 400 N, or not greater than 350 N, or not greater than 300 N, or not greater than 250 N, or not greater than 200 N.

Embodiment 9. The article of any one of the preceding Embodiments, wherein the water stability factor is at least 75%, or at least 80%, or at least 82%, or at least 84%, or at least 86%, or at least 88%, or at least 90%, or at least 92%, or at least 94%, or at least 95%, or at least 96%, or at least 97%, or at least 98%, or at least 99%.

Embodiment 10. The article of any one of the preceding Embodiments, wherein the water stability factor is not greater than 99.9%, or not greater than 99.5%, or not greater than 99.0%.

Embodiment 11. The article of any one of the preceding Embodiments, wherein the first water-insoluble polymer has a water-solubility of not greater than 0.1 g/l, and the second water-soluble polymer has a water-solubility of at least 1 g/l.

Embodiment 14. The article of any one of the preceding Embodiments, wherein the first polymer comprises functional groups selected from hydroxyl groups, amine groups, aldehyde groups, hydroxyl groups, or carbodiimide groups, or any combination thereof.

Embodiment 15. The article of any one of the preceding Embodiments, wherein the second polymer comprises functional groups selected from carboxyl groups, hydroxyl groups, amine groups or any combination thereof.

Embodiment 16. The article of any one of the preceding Embodiments, wherein the first polymer includes an acrylate polymer, or a styrene polymer, or an acrylate copolymer, a styrene-acrylate copolymer, a vinyl acetate copolymer, a styrene-butadiene copolymer, or any combination thereof.

Embodiment 17. The article of Embodiment 16, wherein the first polymer includes an acrylate polymer.

Embodiment 18. The article of any one of the preceding Embodiments, wherein the second polymer includes a polysaccharide, or polyvinyl alcohol (PVA), or a polyethylene glycol (PEG), or a polypropylene glycol (PPG).

Embodiment 19. The article of Embodiment 18, wherein the second polymer includes a polysaccharide.

Embodiment 20. The article of Embodiment 19, wherein the polysaccharide includes a cellulose derivative, or a modified starch, or an alginate.

Embodiment 21. The article of Embodiment 20, wherein the cellulose derivative includes carboxymethyl cellulose (CMC), or hydroxyethyl cellulose (HEC), or hydroxypropyl cellulose (HPC).

Embodiment 22. The article of Embodiment 21, wherein the cellulose derivative includes carboxymethyl cellulose.

Embodiment 23. The article of any one of Embodiments 19-22, wherein the polysaccharide includes a cellulose derivative and an alginate.

Embodiment 24. The article of Embodiment 23, wherein the polysaccharide consists essentially of carboxymethyl cellulose and alginate.

Embodiment 25. The article of any one of Embodiments 23 or 24, wherein a weight percent ratio of the cellulose derivative to the alginate ranges from 2:1 to 1:2, or from 1.5:1 to 1:1.5.

Embodiment 26. The article of any one of the preceding Embodiments, wherein the binder consists essentially of the cross-linked polymer of the first polymer and the second polymer.

Embodiment 27. The article of any one of the preceding Embodiments, wherein a weight percent ratio of the first polymer to the second polymer is at least 1:1, or at least 1.5:1, or at least 2:1, or at least 3:1, or at least 4:1, or at least 5:1, or at least 7:1.

Embodiment 28. The article of any one of the preceding Embodiments, wherein a weight percent ratio of the first polymer to the second polymer is not greater than 50:1, or not greater than 40:1, or not greater than 30:1, or not greater than 20:1 or not greater than 15:1, or not greater than 10:1, or not greater than 7:1.

Embodiment 29. The article of any one of the preceding Embodiments, wherein a molecular weight of the first polymer is at least 10,000 g/mol, or at least 50,000 g/mol, or at least 100,000 g/mol, or at least 500,000 g/mol, or at least 1,000,000 g/mol.

Embodiment 30. The article of any one of the preceding Embodiments, wherein a molecular weight of the first polymer is not greater than 10,000,000 g/mol, or not greater than 5,000,000 g/mol, or not greater than 1,000,000 g/mol, or not greater than 500,000 g/mol, or not greater than 100,000 g/mol.

Embodiment 31. The article of any one of the preceding Embodiments, wherein a molecular weight of the second polymer is at least 2,000 g/mol, or at least 5,000 g/mol, or at least 10,000 g/mol, or at least 50,000 g/mol, or at least 80,000 g/mol, or at least 100,000 g/mol, or at least 200,000 g/mol, or at least 300,000 g/mol, or at least 500,000 g/mol.

Embodiment 32. The article of any one of the preceding Embodiments, wherein a molecular weight of the second polymer is not greater than 1,000,000 g/mol, or not greater than 500,000 g/mol, or not greater than 100,000 g/mol.

Embodiment 33. The article of any one of the preceding Embodiments, wherein the ceramic particles comprise a material capable of adsorbing lithium ions, the material capable of adsorbing lithium ions including lithium titanate, or lithium bayerite, or layered double hydroxide aluminate, or manganese oxide, or any combination thereof.

Embodiment 34. The article of Embodiment 33, wherein the ceramic particles consist essentially of lithium bayerite.

Embodiment 35. The article of Embodiment 33, wherein the ceramic particles consist essentially of lithium titanate.

Embodiment 36. The article of any one of the preceding Embodiments, wherein an average particle size of the ceramic particles is at least 0.1 micron, or at least 0.5 microns, or at least 0.1 microns, or at least 0.3 microns, or at least 0.5 microns, or at least 1 micron, or at least 5 microns, or at least 7 microns, or at least 10 microns.

Embodiment 37. The article of any one of the preceding Embodiments, wherein an average particle size of the ceramic particles is not greater than 2 mm, or not greater than 1.5 mm, or not greater than 1 mm, or not greater than 500 microns, or not greater than 300 microns, or not greater than 100 microns, or not greater than 50 microns, or not greater than 20 microns, or not greater than 10 microns, or not greater than 5 microns, or not greater than 1 micron, or not greater than 0.5 microns.

Embodiment 38. The article of any one of the preceding Embodiments, wherein an amount of the ceramic particles is at least at least 50 wt %, or at least 55 wt %, or at least 60 wt %, or at least 65 wt %, or at least 70 wt %, or at least 75 wt %, or at least 78 wt %.

Embodiment 39. The article of any one of the preceding Embodiments, wherein an amount of the ceramic particles is not greater than 82 wt % based on the total weight of the composite body, or not greater than 80 wt %, or not greater than 78 wt %, or not greater than 75 wt %, or not greater than 70 wt %, or not greater than 65 wt %.

Embodiment 40. The article of any one of the preceding Embodiments, wherein a porosity of the composite body is at least 5 vol %, or at least 10 vol %; or at least 20 vol %, or at least 25 vol %, or at least 30 vol %, or at least 35 vol %, or at least 40 vol %, or at least 45 vol %, or at least 50 vol %, or at least 55 vol %.

Embodiment 41. The article of any one of the preceding Embodiments, wherein a porosity of the composite body is not greater than 80 vol %, or not greater than 75 vol %, or not greater than 70 vol %, or not greater than 65 vol %, or not greater than 60 vol %, or not greater than 55 vol %, or not greater than 50 vol %, or not greater than 45 vol %, or not greater than 40 vol %, or not greater than 35 vol %, or not greater than 30 vol %, or not greater than 25 vol %.

Embodiment 42. The article of any one of the preceding Embodiments, wherein an average pore size (D50) of the composite body is at least 10 nm, or at least 50 nm, or at least 100 nm, or at least 200 nm, or at least 300 nm, or at least 500 nm, or at least 1 micron.

Embodiment 43. The article of any one of the preceding Embodiments, wherein an average pore size (D50) of the composite body is not greater than 5 microns, or not greater than 3 microns, or not greater than 1 micron, or not greater than 0.5 microns, or not greater than 0.2 microns, or not greater than 0.1 microns.

Embodiment 44. The article of any one of the preceding Embodiments, wherein an average surface area of the composite body is at least 5 m²/g, or at least 10 m²/g, or at least 15 m²/g, or at least 20 m²/g.

Embodiment 45. The article of any one of the preceding Embodiments, wherein an average surface area of the composite body is not greater than 50 m²/g, or not greater than 25 m²/g, or not greater than 30 m²/g, or not greater than 20 m²/g, or not greater than 15 m²/g.

Embodiment 46. The article of any one of the Embodiments 1 to 43, wherein the composite body is a grain, a pellet, or a sheet.

Embodiment 47. The article of Embodiment 46, wherein the composite body is a pellet.

Embodiment 48. The article of any one of the preceding Embodiments, wherein the article comprises a plurality of the composite body.

Embodiment 49. The article of Embodiment 48, wherein the plurality of composite bodies have an average particle size (D50) of at least 10 microns, or at least 30 microns, or at least 50 microns, or at least 100 microns, or at least 200 microns, or at least 300 microns, or at least 400 microns, or at least 500 microns.

Embodiment 50. The article of Embodiment 48, wherein the plurality of composite bodies have an average particle size (D50) of not greater than 10,000 microns, or not greater than 5,000 microns, or not greater than 3,000 microns, or not greater than 2000 microns, or not greater than 1000 microns, or not greater than 700 microns.

Embodiment 51. The article of any one of Embodiments 48-50, wherein the plurality of composite bodies have a friability of not greater than 20%, or not greater than 18%, or not greater than 15%, or not greater than 14%, or not greater than 13%, or not greater than 12%, or not greater than 11%, or not greater than 10%, or not greater than 9%, or not greater than 8%, or not greater than 7%, or not greater than 6%, or not greater than 5%, or not greater than 4%, or not greater than 3%, or not greater than 2%, or not greater than 1%.

Embodiment 52. The article of any one of Embodiments 48-51, wherein the plurality of composite bodies have a friability of at least 0.5%, or at least 1%.

Embodiment 53. The article of any one of Embodiments 48-52, wherein the article includes a column filled with the plurality of composite bodies.

Embodiment 54. A method of forming a composite body, comprising: combining ceramic particles capable of adsorbing lithium ions, a first polymer, a second polymer and water to form a green body; curing the green body to obtain a cured body; and mechanically processing the cured body to obtain the composite body, wherein the first polymer is a water-insoluble polymer having a water-solubility at 20° C. not greater than 0.1 g/l, and the second polymer is a water-soluble polymer having a water solubility at 20° C. of at least 1 g/l, and a bulk compression strength of the composite body is at least 70 N.

Embodiment 55. The method of Embodiment 54, wherein the curing is conducted at a temperature of at least 80° C., or at least 100° C., or at least 140° C., or at least 170° C., or at least 200° C.

Embodiment 56. The method of Embodiment 54 or 55, wherein the curing is conducted at a temperature not greater than 450° C., or not greater than 400° C., or not greater than 350° C., or not greater than 300° C., or not greater than 250° C.

Embodiment 57. The method of ay one of Embodiments 54-56, wherein during curing of the green body the first polymer and the second polymer at least partially cross-link with each other to form a cross-linked polymer.

Embodiment 58. The method of any one of Embodiments 54-57, wherein mechanically processing the cured body comprises crushing the cured body and sieving to obtain a plurality of composite bodies.

Embodiment 59. The method of Embodiment 58, wherein after the sieving an average particle size of the plurality of composite bodies is at least 50 microns, or at least 100 microns, or at least 200 microns, or at least 300 microns, or at least 400 microns, or at least 500 microns.

Embodiment 60. The method of Embodiment 58, wherein after the sieving an average particle size of the plurality of composite particles is not greater than 5000 microns, or not greater than 3000 microns, of not greater than 2000 microns, or not greater than 1000 microns, or not greater than 700 microns.

Embodiment 61. The method of any one of Embodiments 54 or 60, wherein the first polymer includes an acrylate polymer, and the second polymer includes a polysaccharide.

Embodiment 62. The method of Embodiment 61, wherein the polysaccharide includes a cellulose derivative, an alginate, or a starch-derivative.

Embodiment 63. The method of Embodiment 62, wherein the cellulose derivative includes carboxymethyl cellulose.

Embodiment 64. The method of any one of Embodiments 61-63, wherein the polysaccharide includes a cellulose derivative and alginate.

Embodiment 65. The method of Embodiment 64, wherein the polysaccharide includes carboxymethyl cellulose and alginate.

Embodiment 66. The method of Embodiment 65, wherein the polysaccharide consists essentially of carboxymethyl cellulose and alginate.

Embodiment 67. The method of Embodiments 65 or 66, wherein a weight percent ratio between the carboxymethyl cellulose and the alginate ranges from 2:1 to 1:2, or from 1.5:1 to 1:1.5.

Embodiment 68. The method of any one of Embodiments 54-67, wherein at least 50 wt % of the second polymer are fully dissolved in the water.

Embodiment 69. The method of any one of Embodiments 54-68, wherein forming the composite body comprises molding or extrusion.

Embodiment 70. The method of any one of Embodiments 54-69, wherein the composite body has a water stability factor (WS) of at least 70%, or at least 75%, or at least 80%, or at least 85%, or at least 90%, or at least 92%, or at least 94%, or at least 96%, or at least 97%, or at least 98%.

Embodiment 71. The method of any one of Embodiments 54-70, wherein the composite body corresponds to the composite body of any one of Embodiments 1-53.

### EXAMPLES

The following non-limiting examples illustrate the present invention.

### Example 1

### Making of Composite Bodies

In a high shear mixer (Eirich EL1) were added 4.4 g sodium carboxymethyl cellulose (CMC) having a molecular weight of about 90,000 g/mol (CMC12M8P from Ashland), 4.4 g sodium alginate (from Millipore Sigma, CAS: 9005-38-3) and 250 g deionized water. The content in the mixer was mixed at 500 rpm for 15 minutes to completely dissolve the polymers in the water. Thereafter, 93.09 g of a water-insoluble acrylate polymer (Rhoplex GL-618, from Dow Chemicals) was added to the polysaccharide polymer solution and the mixture was thoroughly homogenized for 2 minutes at 800 rpm.

Thereafter, 210.11 g of lithium bayerite powder having an average particle size of 5.6 microns and a moisture content of 6 wt % was added to the mixing bowl, and the mixture mixed for 5 minutes at 500 rpm. Deionized water was added to the mixture to form a suspension having a water content of about 55 wt % based on the total weight of the mixture and the suspension was continuously mixed on high pan speed (800 rpm), until the mixture formed a firm dough having about 50 wt % moisture.

The dough was rolled into a one-inch-thick sheet and placed on a wire rack, followed by curing in a drying oven for 5 hours at 200° C. The wire rack allowed a uniform air flow to all sides of the sheet.

Thereafter, the dried and cured dough was broken by hand into small pieces of about 5-20 mm, followed by crushing using a BICO Braun pulverizer to a target size of about 400 microns. The particle fraction between 300-500 microns was separated by sieving for further experiments and characterization, and is called herein sample S1.

The total amount of polymeric binder of the pellets of sample S1 was 21 wt % based on the total weight of polymeric binder and ceramic particles, and the weight % ratio of water-insoluble acrylate polymer (Rhoplex GL-618) to the water-soluble polymer (combination of CMC/Alginate) was 5:1. It could be shown in pre-experiments that a ratio of first polymer to second polymer between 2:1 and 5:1 was of special advantage with regard to strength, water-solubility and adsorption performance, and the ratio of 5:1 between water-insoluble and water-soluble polymer was selected for all further experiments. It was further established in pre-experiments with regard to the selection of the water-soluble polymer that the combination of the two water-soluble polysaccharides CMC and alginate with a weight percent ratio of 1:1 can have an advantage with regard to water adsorption, strength and performance of the pellets, however, using CMC alone as the water-soluble polymer (in combination with the water-insoluble acrylate) was also suitable.

Comparative composite bodies (pellets) were prepared the same way as the pellets of sample S1, except that the water-insoluble acrylate polymer Rhoplex GL-618 was replaced with a water-insoluble styrene-acrylic polymer (Acronal Pro 770 NA, from BASF). As water-soluble polymer was used the same combination of CMC/arginite as for sample S1. Furthermore, sample C1 also had the weight percent ratio of water-insoluble polymer to water-soluble polymer of 5:1, and a total amount of polymeric binder being 21 wt % based on the total weight of the binder and ceramic particles.

The pellets of samples S1 and C1 were tested with regard to the water stability, mechanical strength, lithium adsorption capacity (breakthrough capacity @ Li/L0=1 mg/g and total capacity), and dry tap density.

A summary of the test data is shown in Table 1.

TABLE 1

| | | | | | | Break- | |
|---|---|---|---|---|---|---|---|
| | | | | | | through | Total |
| | | | Water | | Tap | Capa- | Capa- |
| Sam- | First | Second | Stability | Strength | density | city | city |
| ple | Polymer | Polymer | [%] | [N] | [g/cm3] | [mg/g] | [mg/g] |
| S1 | Rhoplex | CMC/ | 97.68 | 168.1 | 0.58 | 3.9 | 5.3 |
| | GL-618 | Acrylate | | | | | |
| C1 | Acronal | CMC/ | 96.35 | 62.0 | 0.55 | 3.0 | 4.9 |
| | Pro 777 | Acrylate | | | | | |

It can be seen from the data summarized in Table 1 that the pellets of Sample 1 were superior in the strength, breakthrough capacity and total capacity in comparison to sample C1, while the water stability was similar. It is remarkable that the strength of the pellets of sample S1 was about 270% higher if compared with the strength of the pellets of sample C1.

### Measuring of the Water Stability Factor (WS)

The pellets obtained according to the above-described method were sieved over a 50-mesh sieve. For the testing of the water stability of the pellets, 2 g of the sieved pellets were dried in a moisture analyzer at a temperature of 60° C. until completely dry and weight stable. After the drying, the exact weight of the pellets was measured followed by pouring the pellets into a 150 ml size beaker filled with 100 ml deionized water. The pellet-water mixture was hand-stirred with a plastic spatula and thereafter allowed to stand for 30 minutes. After 30 minutes, the mixture was hand-stirred again with the plastic spatula, followed by separating the water-treated pellets from the mixture via sieving with a 60-mesh sieve. The water-stability factor (WS) was calculated according to the following equation: WS [%]=(dry weight of water-treated pellets/dry weight of original pellets)×100%.

### Measuring of the Bulk Compression Strength of the Pellets

The strength of the pellets was measured by subjecting a defined volume of the pellets to compression and recording the force at which the volume of the test sample was reduced by 10 percent, which is called herein “bulk compression strength.” For the testing, pellets dried at 60° C. to a stable weight and having a size range between 300 microns and 500 microns were used. The testing was conducted using an Instron 3366 equipped with a 10 kN load cell. The pellets were filled into a round stainless steel cylinder having an inner diameter of 10 mm up to a height of 20 mm to form a pellet bed, which corresponds to a volume of 1.57 cm3. At the beginning of the test, particle displacement was zeroed with a die force of 5 N on the outer surface of the pellet bed, and the exact height of the bed was recorded. Thereafter, the pellet bed was subjected to compression via the die moving downward at a speed of 5 mm/minute until reaching the force of 1 kN. The bulk compression strength was determined as the force at which the pellet bed was displaced by 10% of its original height, which can be also called interchangeable “10 volume percent bulk reduction compression strength.” All tests were conducted under air and ambient temperature.

### Measurement of Capacity for Adsorbing Lithium-Ions

As starting material for the testing were used dried pellets (dried to a stable temperature at 60° C.) having a size between 300 and 500 microns. The test was conducted at ambient temperature and pressure and at a flowrate of eight bed volumes (300 ml) per hour.

For the lithium ion adsorption testing a column having a diameter of 1 inch was filled with the pellets to a bed volume of 37.5 cm3. In a first procedure, the pellets were activated by passing 32 bed volumes (1200 ml) of a lithium chloride solution having a concentration of 155 mg/L lithium ions, through the column. The purpose of the activation is to remove all desorbable lithium ions from the pellets (the sorbent material). Thereafter, 18 bed volumes (300 ml) of a simulated brine with a concentration of 360 mg/L lithium ions was passed through the column. The brine further contained 44,000 mg/L sodium ions; 30,400 mg/L calcium ions; 16,500 mg/L potassium ions; and 1420 mg/L magnesium ions, with the counter-anions being chloride.

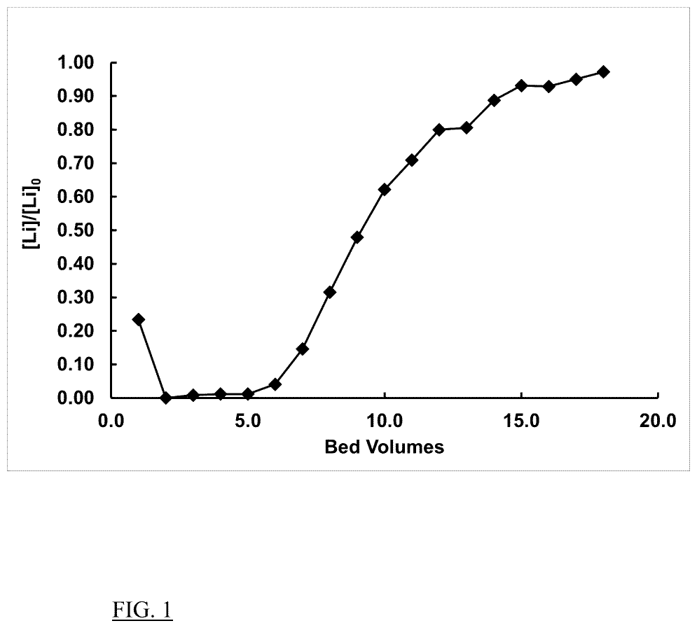

The cycle of passing activation solution followed by brine solution through the column was repeated, wherein during the second cycle lithium adsorbed from the brine was desorbed again with the activation solution to start the lithium adsorption new. An adsorption curve was created during the second cycle, when beginning passing the brine solution during the column. An example of a lithium ion adsorption curve is shown in FIG. 1, which is a testing curve of the pellets of sample S1. The y-axis shows the ratio Li/Li0, which means the ratio of the lithium-ion concentration in the brine exiting the column to the lithium-ion concentration of the brine before entering the column (Li). When all lithium ions contained in the brine are adsorbed, the value of the y axis is 0, while, for example, a 90% lithium-ion adsorption by the pellets corresponds to a value of 0.1 on the y-axis. It can be seen from the curve of FIG. 1 that all lithium ions of the brine were adsorbed until a passing of about 5 bed volumes brine (187.5 ml), while with further passing of brine the adsorption efficiency decreased. As used herein, the breakthrough capacity of the tested pellets corresponds to the amount of lithium ions adsorbed until the efficiency decreased from 100% to 90% lithium ion adsorption (90% Li adsorption corresponding to [Li]/[Li]0 of 0.1). The lithium-ion content in the brine was measured via ICP analysis. The calculated amount of lithium ions adsorbed by the pellets in mg/g adsorbent (pellets) at the ratio [Li]/[Li]0=0.1 was used as the breakthrough capacity herein. The total capacity of lithium ion adsorption was calculated after 18 bed volumes, at which point the adsorption test was ended.

### Measurement of Tap Density

The sample of pellets to be tested, which was dried before the testing at 60° C. to a stable weight, was added to a cylinder having a diameter of 2.54 cm and markings with regard to the height of the cylinder. The pellets were added to the cylinder until a height of 7.4 cm was reached, which corresponds to a volume of 37.5 cm3. While filling the cylinder with the pellets, the sides of the cylinder were repeatedly tapped with a lightly padded rod, helping the particles to settle into a tightly packed orientation. After reaching the height of 7.4 cm, the cylinder was weighed, and the amount of pellets in the cylinder was calculated by the difference between the weight of the filled cylinder and the weight of the empty cylinder (before filling with the sample). The tap density was calculated by dividing the amount of pellets with the bed volume of 37.5 cm³.

### Preparing of Lithium Bayerite Powder

An aqueous slurry containing 361 g aluminum trihydrate (ATH) in 1380 g water (20 wt % ATH) was added to a reactor of a wet mill (Netzsch LabStar LS1). The reactor further contained 0.8 mm size alumina beads for conducting the milling. The mixture was subjected to 5 minutes milling, followed by adding 98.1 g LiOH, H₂O (99% purity, from Leverton). The mixture was milled for another 5 minutes, followed by adding 196.2 g LiCl (purity 99%, from Leverton). Thereafter, the mixture was heated to a temperature of 60° C. and maintained at 60° C. for one hour. The heating was discontinued and the pH lowered to a pH of 7 by adding 16 wt % hydrochloric acid. A sample was taken from the reactor to prove that the particle size of the formed particles has an average particle size below 1 micron. If the particle size is below the maximum value of 1 micron, milling of the mixture was stopped and the slurry was filtered over a Buechner filter using filter paper having a 2.5 microns permeability (from Whatman). The obtained gel remaining in the filter containing the formed lithium bayerite was further dried on a flat sheet at 60° C., and pulverized easily when reaching a moisture content of 14 wt % or lower.

### Example 2

A series of different batches of pellets (composite bodies) was prepared the same way as described in Example 1 for sample S1, except that the total amount of polymeric binder was varied between 5 wt % and 30 wt % based on the total weight of polymeric binder and lithium bayerite. The weight percent ratio between the water-insoluble Rhoplex polyacrylate and the water-soluble mixture of CMC/arginite was 5:1, as in sample S1.

A summary of the samples is shown in Table 2. At a binder amount of 5 wt %, no pellets could be prepared which were strong enough to hold as pellets together and being submitted to the testing. It was possible to obtain water-stable pellets at a binder amount of 10 wt %, however, these pellets had an inferior strength compared to pellets formed with higher binder amounts. As can be seen from Table 2, the strength of pellets made with the polymeric binder in an amount of 10 wt % (62N) compared to the strength of pellets formed with 21 wt % of the polymeric binder (168.1 N) is an increase in strength of about 270 percent.

TABLE 2

| | Total | Water | | Tap | Breakthrough | Total |
|---|---|---|---|---|---|---|
| | wt % | Stability | Strength | density | Capacity | Capacity |
| Sample | binder | [%] | [N] | [g/cm³] | [mg/g] | [mg/g] |
| C2 | 5 | — | — | — | — | — |
| C3 | 10 | 95.8 | 62.0 | 0.47 | 4.4 | 6.5 |
| S2 | 13 | bm | bm | bm | bm | bm |
| S3 | 15 | 95.7 | bm | 0.62 | 3.7 | 5.6 |
| S4 | 18 | bm | bm | bm | bm | bm |
| S1 | 21 | 97.7 | 168.1 | 0.58 | 3.9 | 5.3 |
| S5 | 23 | bm | bm | bm | bm | bm |
| S6 | 25 | 98.7 | bm | 0.64 | 2.9 | 4.7 |
| S7 | 28 | bm | bm | bm | bm | bm |
| S8 | 30 | bm | bm | bm | bm | bm |

(“bm”—being measured)

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

What is claimed is:

1. An article comprising a composite body, the composite body comprising ceramic particles distributed within a binder, the binder including a cross-linked polymer of a first polymer and a second polymer,
wherein
the first polymer includes at least one water-insoluble polymer and the second polymer includes at least one water-soluble polymer;
the composite body has a water stability factor (WS) of at least 70%;
the composited body is adapted for adsorbing and desorbing lithium ions; and
the composite body has a bulk compression strength of at least 70 N.

2. The article of claim 1, wherein an amount of the binder is at least 13 wt % based on the total weight of the composite body.

3. The article of claim 1, wherein a breakthrough capacity for adsorbing lithium ions of the composite body is at least 3.5 mg/g.

4. The article of claim 1, wherein the water stability factor is at least 95%.

5. The article of claim 1, wherein the first polymer includes an acrylate polymer, or a styrene polymer, or an acrylate copolymer, a styrene-acrylate copolymer, a vinyl acetate copolymer, a styrene-butadiene copolymer, or any combination thereof.

6. The article of claim 5, wherein the first polymer includes an acrylate polymer.

7. The article of claim 1, wherein the second polymer includes a polysaccharide, or polyvinyl alcohol (PVA), or a polyethylene glycol (PEG), or a polypropylene glycol (PPG).

8. The article of claim 7, wherein the second polymer includes a polysaccharide.

9. The article of claim 8, wherein the polysaccharide includes a cellulose derivative, or a modified starch, or an alginate.

10. The article of claim 9, wherein the polysaccharide includes carboxymethyl cellulose.

11. The article of claim 9, wherein the polysaccharide includes carboxymethyl cellulose and alginate.

12. The article of claim 1, wherein a weight percent ratio of the first polymer to the second polymer is at least 2:1 and not greater than 7:1.

13. The article of claim 1, wherein a material of the ceramic particles includes lithium titanate, or lithium bayerite, or layered double hydroxide aluminate, or manganese oxide, or any combination thereof.

14. The article of claim 13, wherein the ceramic particles consist essentially of lithium bayerite.

15. The article of claim 1, wherein the composite body is a grain, a pellet, or a sheet.

16. The article of claim 1, wherein the article comprises a plurality of the composite body.

17. The article of claim 16, wherein the plurality of composite bodies have an average particle size (D50) of at least 10 microns and not greater than 5000 microns.

18. The article of claim 16, wherein the article includes a column filled with the plurality of composite bodies.

19. A method of forming a composite body, comprising:
combining ceramic particles capable of adsorbing lithium ions, a first polymer, a second polymer and water to form a green body;
curing the green body to obtain a cured body; and
mechanically processing the cured body to obtain the composite body,
wherein the first polymer is a water-insoluble polymer having a water-solubility at 20° C. not greater than 0.1 g/l, and the second polymer is a water-soluble polymer having a water solubility at 20° C. of at least 1 g/l,
a water-stability factor of the composite body is at least 70%, and
a bulk compression strength of the composite body is at least 70 N.

20. The method of claim 19, wherein during curing of the green body, the first polymer and the second polymer at least partially cross-link with each other to form a cross-linked polymer.
